(19) United States
(12) Patent Application Publication
(10) Pub. No.: US 2011/0177305 A1
(43) Pub. Date: Jul. 21, 2011

(54) POLISHING PAD AND METHOD FOR MAKING THE SAME

(75) Inventors: Chung-Chih FENG, Kaohsiung (TW); Chun-Ta WANG, Kaohsiung (TW); Kun-Cheng TSAI, Kaohsiung (TW); Yung-Chang HUNG, Kaohsiung (TW); I-Peng YAO, Kaohsiung (TW); Kao-Lung YANG, Kaohsiung (TW); Chih-Yi LIN, Kaohsiung (TW)

(73) Assignee: SAN FANG CHEMICAL INDUSTRY CO., LTD., KAOHSIUNG (TW)

(21) Appl. No.: 12/760,062

(22) Filed: Apr. 14, 2010

(30) Foreign Application Priority Data
Jan. 20, 2010 (TW) 099101518

(51) Int. Cl. B32B 27/02; B32B 27/04; B32B 27/40; B32B 27/30

(52) U.S. Cl. 428/196; 442/164; 442/167; 427/256; 442/171; 442/60

(57) ABSTRACT

The present invention relates to a polishing pad and method for making the same. The polishing pad includes a fabric substrate and a second high polymeric elastomer resin. The fabric substrate is formed by a plurality of cross composite fibers. Each composite fiber has a plurality of fine fibers and a first high polymeric elastomer resin, and the first high polymeric elastomer resin discontinuously encloses the fine fibers. The second high polymeric elastomer resin encloses the composite fibers, and the first high polymeric elastomer resin and the second high polymeric elastomer resin have the same functional group. By adjusting the degree of saturation of the first high polymeric elastomer resin and the second high polymeric elastomer resin, the fine fibers will have smaller size and will not be easily entangled. Therefore, a workpiece to be polished will not be scratched and will have excellent surface quality.

### BACKGROUND OF THE INVENTION

1. Field of the Invention

The present invention relates to a polishing pad and method for making the same, and more particularly to a polishing pad and method for making the same without using strong acids or strong bases for fiber opening.

2. Description of the Related Art

In conventional mechanical polishing methods, the wafer surface is easily scratched due to high denier of fibers and accumulation of abrasive slurry particles in the pores of the polishing pad. Therefore, currently, fine fibers are used in the fiber substrate in order to prevent scratching, or the degree of saturation and hardness of the polishing pad are adjusted by multiple immersion, and the properties and content of high polymeric elastomers as well as the solid content and modulus may also be adjusted so as to control the hardness, compressibility, and flatness of the polishing pad, as disclosed by, for example, Taiwan (ROC) Patent Publication No. 491757 entitled “ABRASIVE SHEET FOR TEXTURING AND METHOD OF PRODUCING SAME”.

However, in the conventional process of making the fabric substrate into fine fibers (fiber opening), a strong acid or base solution generally has to be used. The solution needs to be treated after use, which increases the cost and pollutes the environment. In addition, the fiber opening process is performed after the fabric substrate is immersed in a high polymeric elastomer; therefore, after some of the fibers are removed, the elastomer in the polishing pad cannot be completely bonded to the fabric substrate. As a result, the fibers will fall off easily and get entangled on the surface of the polishing pad during the polishing process. In order to avoid the above disadvantages, in another conventional method, the fabric substrate is immersed many times; however, this method is complicated, inefficient, and costly.

Therefore, it is necessary to provide an innovative and inventive polishing pad and method for making the same to solve the above problems.

### SUMMARY OF THE INVENTION

The present invention provides a method for making a polishing pad, which includes: (a) providing a plurality of composite fibers, in which each composite fiber has a plurality of fine fibers and a first high polymeric elastomer resin, and the first high polymeric elastomer resin encloses the fine fibers; (b) crossing the composite fibers to form a fabric substrate; and (c) impregnating the fabric substrate in a second high polymeric elastomer resin solution, in which the second high polymeric elastomer resin solution contains a second high polymeric elastomer resin, and the second high polymeric elastomer resin and the first high polymeric elastomer resin have the same functional group, so that the first high polymeric elastomer resin is dissolved in the second high polymeric elastomer resin solution to expose a partial segment of the fine fibers.

The present invention further provides a polishing pad, which includes a fabric substrate and a second high polymeric elastomer resin. The fabric substrate is formed by a plurality of cross composite fibers. Each composite fiber has a plurality of fine fibers and a first high polymeric elastomer resin, and the first high polymeric elastomer resin discontinuously encloses the fine fibers. The second high polymeric elastomer resin encloses the composite fibers, and the first high polymeric elastomer resin and the second high polymeric elastomer resin have the same functional group.

In the present invention, no strong acid or base solutions need to be used for fiber opening, so the solution can be recovered for reuse, which reduces not only the environmental impact but also the cost. Moreover, in the present invention, by adjusting the degree of saturation of the first high polymeric elastomer resin and the second high polymeric elastomer resin in the polishing pad, the abrasive slurry particles will not easily accumulate in the pores of the polishing pad, and the fine fibers will have smaller size and will not be easily entangled. Therefore, a workpiece to be polished will not be scratched and will have excellent surface quality.

### BRIEF DESCRIPTION OF THE DRAWINGS

FIG. 1 is a cross-sectional view of a composite fiber used in the present invention;

FIG. 2 is a cross-sectional view of a polishing pad according to the present invention;

FIG. 3 is a partial cross-sectional view of a region A in the polishing pad of FIG. 2; and

FIG. 4 is a cross-sectional view of a polishing pad according to another embodiment of the present invention.

### DETAILED DESCRIPTION OF THE INVENTION

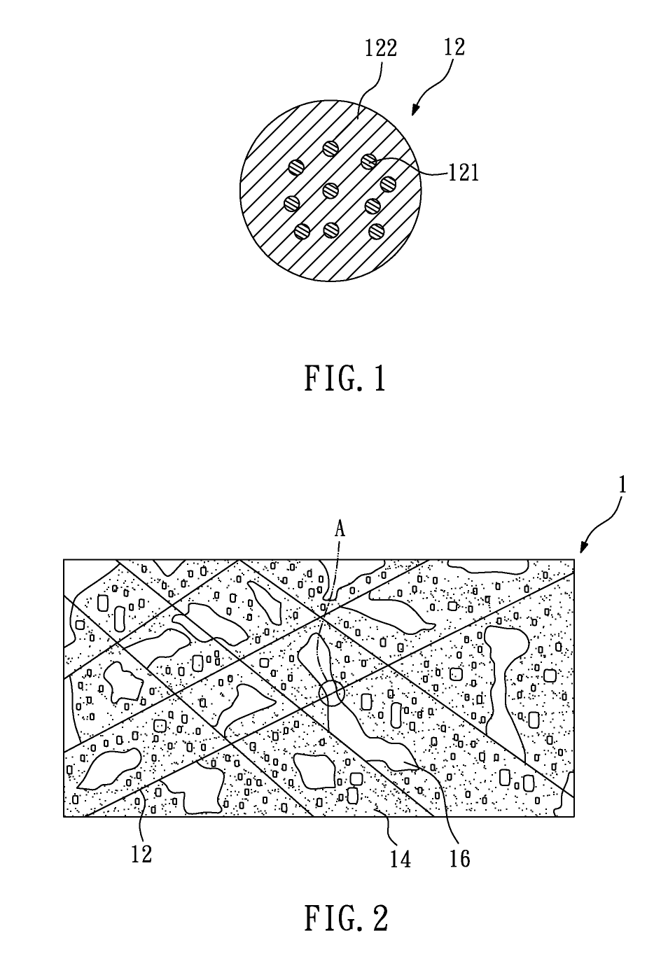

The present invention relates to a method for making a polishing pad, which includes the following steps. First, as shown in FIG. 1, a plurality of composite fibers 12 is provided. Each composite fiber 12 has a plurality of fine fibers 121 and a first high polymeric elastomer resin 122, and the first high polymeric elastomer resin 122 encloses the fine fibers 121. The material of the fine fibers 121 is selected from the group consisting of polyethylene terephthalate (PET), nylon, polypropylene (PP), polyester resin, acrylic resin, and polyacrylonitrile resin. In an embodiment, the composite fibers 12 have a fineness of lower than 6 den, the fine fibers 121 have a fineness of lower than 0.5 den, and the weight ratio of the fine fibers 121 to the first high polymeric elastomer resin 122 in the composite fibers 12 is 4:6.

The first high polymeric elastomer resin is thermoplastic urethane (TPU). In this embodiment, the composite fibers 12 are sea-island fibers, wherein the fine fibers 121 are island component, and the first high polymeric elastomer resin 122 is sea component. However, in other applications, the composite fibers 12 may also be segmented fibers.

Then, the composite fibers 12 are crossed to form a fabric substrate. In an embodiment, the fabric substrate is a non-woven fabric, and the composite fibers 12 are crossed by a bonding method (such as needle punching, water jetting, or hot pressing) to form the fabric substrate.

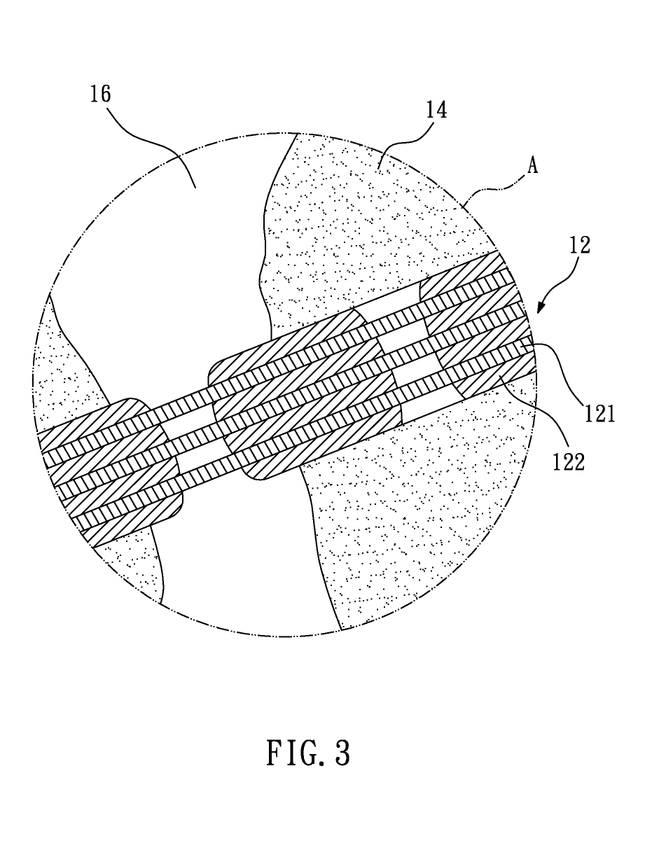

Next, the fabric substrate is impregnated in a second high polymeric elastomer resin solution so as to perform a fiber opening process, in which the second high polymeric elastomer resin solution contains a second high polymeric elastomer resin, and the second high polymeric elastomer resin and the first high polymeric elastomer resin 122 have the same functional group. As a result, the first high polymeric elastomer resin 122 is dissolved in the second high polymeric elastomer resin solution to expose a partial segment of the fine fibers 121, as shown in FIGS. 2 and 3. Afterward, the fabric substrate is set by curing the second high polymeric elastomer resin solution and removing the solvent, so that the unexposed portion of the fine fibers 121 is completely bonded to the high polymeric elastomer. Then, rinsing, drying, and abrading steps are performed, so as to fabricate a finished polishing pad.

The second high polymeric elastomer resin is selected from the group consisting of TPU, polyamide resin, polycarbonate, melamine resin, polymethacrylic resin, epoxy resin, phenol resin, polyurethane resin, vinylbenzene resin, acrylic resin, and mixtures thereof.

The second high polymeric elastomer resin solution further contains a solvent and a surfactant, and on the basis of the total weight of the second high polymeric elastomer resin solution, the second high polymeric elastomer resin is 10 wt % to 60 wt %, the solvent is 40 wt % to 90 wt %, and the surfactant is 1 wt % to 10 wt %. The solvent is selected from the group consisting of dimethylformamide (DMF), toluene, cyclohexanone, methyl ethyl ketone, and mixtures thereof.

Preferably, the second high polymeric elastomer resin and the first high polymeric elastomer resin are of the same material.

FIG. 2 shows a cross-sectional view of a polishing pad according to the present invention. FIG. 3 shows a partial cross-sectional view of a region A in the polishing pad of FIG. 2. As shown in FIGS. 2 and 3, the polishing pad 1 includes a fabric substrate and a second high polymeric elastomer resin 14. The fabric substrate is formed by a plurality of cross composite fibers 12. Each composite fiber 12 has a plurality of fine fibers 121 and a first high polymeric elastomer resin 122, and the first high polymeric elastomer resin 122 discontinuously encloses the fine fibers 121.

In an embodiment, the composite fibers 12 have a fineness of lower than 6 den, and the fine fibers 121 have a fineness of lower than 0.5 den. The composite fibers 12 are sea-island fibers, with the fine fibers 121 as an island component, and the first high polymeric elastomer resin 122 as a sea component. However, in other applications, the composite fibers 12 may also be segmented fibers.

The fabric substrate is a non-woven fabric. The material of the fine fibers 121 is selected from the group consisting of PET, nylon, PP, polyester resin, acrylic resin, and polyacrylonitrile resin. The first high polymeric elastomer resin is TPU. The second high polymeric elastomer resin 14 encloses the composite fibers 12, and the second high polymeric elastomer resin 14 and the first high polymeric elastomer resin 122 have the same functional group. The second high polymeric elastomer resin 14 is selected from the group consisting of polyamide resin, polycarbonate, melamine resin, polymethacrylic resin, epoxy resin, phenol resin, polyurethane resin, vinylbenzene resin, acrylic resin, and mixtures thereof.

The second high polymeric elastomer resin 14 has a plurality of pores 16 in communication with each other.

As shown in FIG. 3, a partial segment of the fine fibers 121 is not enclosed by the first high polymeric elastomer resin 122 and the second high polymeric elastomer resin 14. By adjusting the material of the second high polymeric elastomer resin and the weight percentage of the second high polymeric elastomer resin based on the total weight of the second high polymeric elastomer resin solution, the solubility and degree of dilution of the first high polymeric elastomer resin 122 may be changed, thereby determining the size and proportion of the segment of the fine fibers 121 that is not enclosed (i.e., the exposed segment).

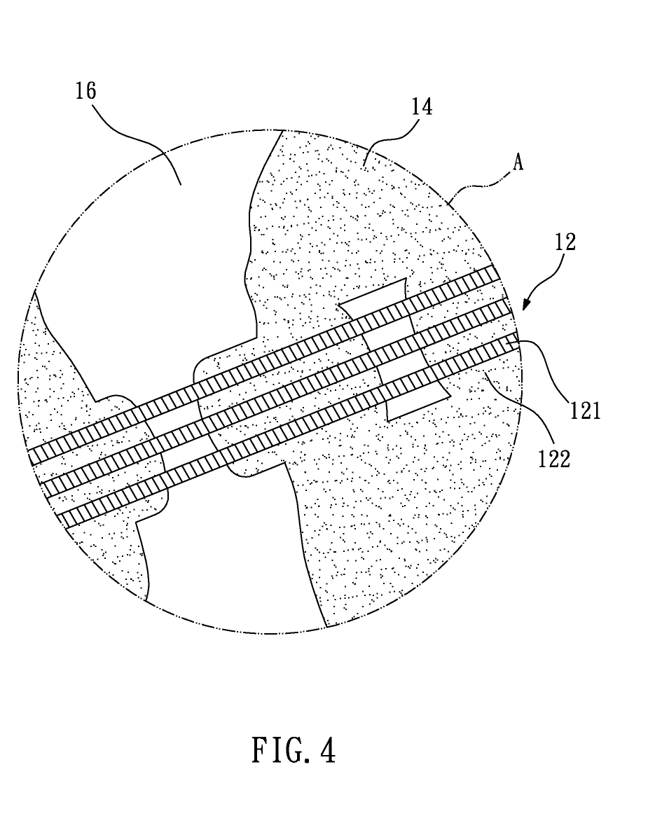

In an embodiment, the second high polymeric elastomer resin and the first high polymeric elastomer resin have the same material, as shown in FIG. 4. It should be noted that, in FIG. 4, the second high polymeric elastomer resin and the first high polymeric elastomer resin are completely bonded to form one component, and are thus both represented by a reference numeral 14.

The present invention has the following advantages. In the process of making the fabric substrate into fine fibers (fiber opening), no strong acid or base solutions need to be used, so the solution can be recovered for reuse, which reduces not only the environmental impact but also the cost. Moreover, in the present invention, by adjusting the degree of saturation of the first high polymeric elastomer resin 122 and the second high polymeric elastomer resin 14 in the polishing pad 1, the abrasive slurry particles will not easily accumulate in the pores 16 of the polishing pad 1, and the fine fibers 121 will have smaller size and will not be easily entangled. Therefore, a workpiece to be polished will not be scratched and will have excellent surface quality.

Examples are given below to illustrate the present invention, and the present invention is not limited thereto.

### EXAMPLE 1

First, a plurality of composite fibers is provided. Each composite fiber has fine fibers of nylon with a fineness of 3 den and a first high polymeric elastomer resin being PET. Then, the composite fibers are needle-punched to form a non-woven fabric (i.e., non-woven base fabric), in which the proportion of nylon and PET is 70% and 30%.

Next, the non-woven fabric is impregnated in a second high polymeric elastomer resin solution. The second high polymeric elastomer resin solution is composed of polyurethane resin, DMF solvent, and a surfactant, and on the basis of the total weight of the second high polymeric elastomer resin solution, polyurethane resin is about 50 wt %, DMF solvent is about 49%, and the surfactant is about 1 wt %.

After the non-woven fabric is impregnated in the second high polymeric elastomer resin solution, the non-woven fabric is placed in a coagulation water bath to permit coagulation and replacement of the second high polymeric elastomer resin solution penetrating the non-woven fabric with an aqueous DMF solution, so that the non-woven fabric is bonded to the high polymeric elastomer having a plurality of pores in communication with each other after curing. An aqueous solution containing 25% of DMF may be present in the coagulation water bath.

Then, the non-woven fabric is placed in a rinsing bath, so as to wash away impurities and DMF solvent penetrating the non-woven fabric by extrusion and drawing functions of an extrusion wheel. The rinsing temperature is controlled at 80° C., and the residual DMF solvent and surfactant are washed away at the high rinsing temperature by continuous extrusion (air pressure=4.0 kg).

After rinsing is completed, the non-woven fabric is introduced into a high-temperature heating apparatus (140° C.) and dried by water evaporation, so as to form a semi-finished polishing pad.

Then, the surface of the semi-finished polishing pad is dressed by a mechanical abrading machine, so as to obtain a 1.28 mm thick finished polishing pad having planar surfaces. The abrading machine uses 150 mesh and 400 mesh sand papers, rates of revolution of 1200 and 1300 rpm, and a load current of 28 A as parameters for abrading and dressing.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A polishing pad, comprising:
a fabric substrate, formed by a plurality of cross composite fibers, wherein each composite fiber has a plurality of fine fibers and a first high polymeric elastomer resin, and the first high polymeric elastomer resin discontinuously encloses the fine fibers; and
a second high polymeric elastomer resin, enclosing the composite fibers, wherein the first high polymeric elastomer resin and the second high polymeric elastomer resin have the same functional group.

2. The polishing pad according to claim 1, wherein the material of the fine fibers is selected from the group consisting of polyethylene terephthalate (PET), nylon, polypropylene (PP), polyester resin, acrylic resin, and polyacrylonitrile resin.

3. The polishing pad according to claim 1, wherein the first high polymeric elastomer resin is thermoplastic urethane (TPU).

4. The polishing pad according to claim 1, wherein a partial segment of the fine fibers is not enclosed by the first high polymeric elastomer resin and the second high polymeric elastomer resin, and the second high polymeric elastomer resin is selected from the group consisting of polyamide resin, polycarbonate, melamine resin, polymethacrylic resin, epoxy resin, phenol resin, polyurethane resin, vinylbenzene resin, acrylic resin, and mixtures thereof.

5. The polishing pad according to claim 1, wherein the composite fibers are sea-island fibers or segmented fibers, with the fine fibers as an island component, and the first high polymeric elastomer resin as a sea component.

6. A method for making a polishing pad, comprising:
(a) providing a plurality of composite fibers, wherein each composite fiber has a plurality of fine fibers and a first high polymeric elastomer resin, and the first high polymeric elastomer resin encloses the fine fibers;
(b) crossing the composite fibers to form a fabric substrate; and
(c) impregnating the fabric substrate in a second high polymeric elastomer resin solution, wherein the second high polymeric elastomer resin solution comprises a second high polymeric elastomer resin, and the second high polymeric elastomer resin and the first high polymeric elastomer resin have the same functional group, so that the first high polymeric elastomer resin is dissolved in the second high polymeric elastomer resin solution to expose a partial segment of the fine fibers.

7. The method according to claim 6, wherein the material of the fine fibers in Step (a) is selected from the group consisting of polyethylene terephthalate (PET), nylon, polypropylene (PP), acrylic resin, and polyacrylonitrile resin.

8. The method according to claim 6, wherein the first high polymeric elastomer resin in Step (a) is thermoplastic urethane (TPU).

9. The method according to claim 6, wherein the composite fibers in Step (a) are sea-island fibers or segmented fibers, with the fine fibers as an island component, and the first high polymeric elastomer resin as a sea component.

10. The method according to claim 6, further comprising a step of curing the second high polymeric elastomer resin solution after Step (c).
